(19) United States
(12) Patent Application Publication
(10) Pub. No.: US 2013/0307345 A1
(43) Pub. Date: Nov. 21, 2013

(54) REPEATER DEVICE FOR WIRELESS POWER TRANSFER

(71) Applicant: KABUSHIKI KAISHA TOSHIBA, Tokyo (JP)

(72) Inventor: Katsuyuki KOBAYASHI, Kanagawa-ken (JP)

(73) Assignee: KABUSHIKI KAISHA TOSHIBA, Tokyo (JP)

(21) Appl. No.: 13/780,829

(22) Filed: Feb. 28, 2013

(30) Foreign Application Priority Data
May 17, 2012 (JP) 2012-113307

(51) Int. Cl. H04B 5/00

(52) U.S. Cl. CPC H04B 5/0037
USPC 307/104

(57) ABSTRACT

According to one embodiment, a repeater device for wireless power transfer having repeaters, measuring units and a control unit is provided. The repeaters supply electric power wirelessly and are placed in a plane substantially. Each of the repeaters has a repeater coil and a switch which enables disconnection of a current path of the repeater coil. The measuring units are provided for measuring respective power transfer efficiencies of the repeaters respectively. The control unit controls switching-on and switching-off of the switches of the repeaters based on a measuring result of the power transfer efficiencies obtained from the measuring units.

### CROSS-REFERENCE TO RELATED APPLICATION

This application is based upon and claims the benefit of priority from the prior Japanese Patent Application No. 2012-113307, filed on May 17, 2012, the entire contents of which are incorporated herein by reference.

### FIELD

Embodiments described herein relate generally to a repeater device for wireless power transfer.

### BACKGROUND

A wireless power transfer system using a magnetic resonance technology is known. When it is desired to extend a power transmission distance or a power transmission range, repeaters having repeater coils respectively are provided in a wireless power transfer system. The repeaters are placed between a power transmission device having a transmission coil and a power receiving device having a receiving coil. The repeaters are placed in series when it is desired to extend the power transmission distance. On the other hand, the repeaters are in parallel when it is desired to enlarge the power transmission range.

A plate-shaped repeater device in which plate-shaped repeaters are placed in a plane is known. The repeater device is placed above a power transmission device, and a power receiving device is above the repeater device.

In this case, when an area of a principal surface of the plate-shaped repeater device is enlarged and the number of the repeaters placed above the power transmission device is increased, a plurality of power receiving devices can be placed at an arbitrary position above the principal surface. It is desirable that electric power can be supplied to such a power receiving device even if the power receiving device is placed above any positions of the repeaters. Accordingly, any of the repeaters are driven so as to resonate with the power transmission device.

However, when the number of power receiving devices placed above a principal surface of a is small, for example, 1 (one), repeaters which are located far from the power receiving device do not contribute much to supplying power to the power receiving device. As a result, the power relaying efficiency of the repeater device as a whole is lowered.

### BRIEF DESCRIPTION OF THE DRAWINGS

FIG. 1 is a block diagram showing a repeater device for wireless power transfer according to a first embodiment.

FIG. 2 is a block diagram showing an example of a repeater constituting the repeater device.

FIG. 3 is a block diagram showing an example of a measuring unit constituting the repeater device which measures power transfer efficiency.

FIG. 4 is a schematic view showing an example of a wireless power transfer system using the repeater device.

FIG. 5 is a view showing an example of a measurement result obtained by the measuring unit.

FIG. 6 is a view showing an example of an aspect of a switching control performed by a control unit constituting the repeater device.

FIG. 7 is a view showing an example of a measurement result obtained by the measuring unit and an example of a determination reference of the control unit.

FIG. 8 is a view showing an example of an aspect of a switching control performed by the control unit.

FIG. 9 is a waveform chart showing examples of switch control signals in a repeater device for wireless power transfer according to a second embodiment.

FIGS. 10A and 10B are views for explaining a case where a power receiving device is placed in addition to another power receiving device above a repeater device of the second embodiment.

FIG. 11 is a waveform chart showing examples of switch control signals of the repeater device in placement state of power receiving device shown in FIG. 10B.

FIG. 12 is a block diagram showing a repeater device for wireless power transfer of a third embodiment.

### DETAILED DESCRIPTION

According to one embodiment, a repeater device for wireless power transfer having s, measuring units and a control unit is provided. The repeaters supply power wirelessly and are placed in a plane substantially. Each of the repeaters has a repeater coil and a switch which enables disconnection of a current path of the repeater coil. The measuring units are provided for measuring power transfer efficiencies of the repeaters respectively. The control unit controls switch on and off of the switches of the repeaters based on a measuring result of the power transfer efficiencies obtained from the measuring units.

Hereinafter, further embodiments will be described with reference to the drawings.

In the drawings, the same reference numerals denote the same or similar portions respectively.

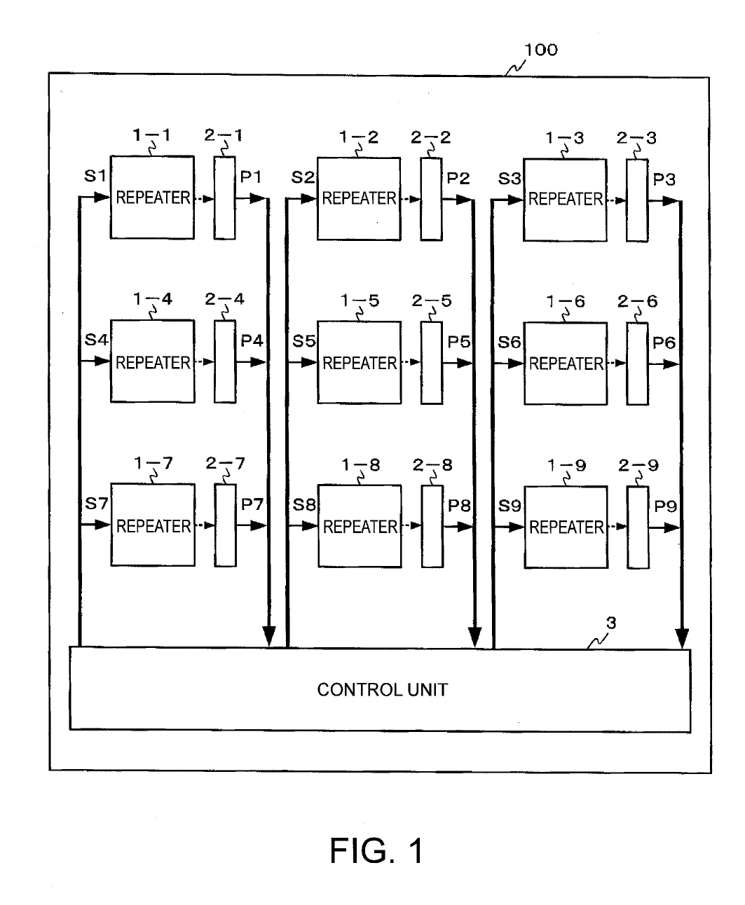

A first embodiment will be described with reference to FIG. 1. FIG. 1 is a block diagram showing an example of a repeater device of the first embodiment.

As shown in FIG. 1, a repeater device 100 for wireless power transfer according to the embodiment is provided with 9 plate-shaped repeaters 1-1 to 1-9, for example. The repeaters 1-1 to 1-9 are placed in a plane. In FIG. 1 shows an example in which the repeaters 1-1 to 1-9 are placed in a 3*3 matrix.

The number of the repeaters 1-1 to 1-9 and the form of the placement of the repeaters are not limited to the example, and can be set arbitrarily.

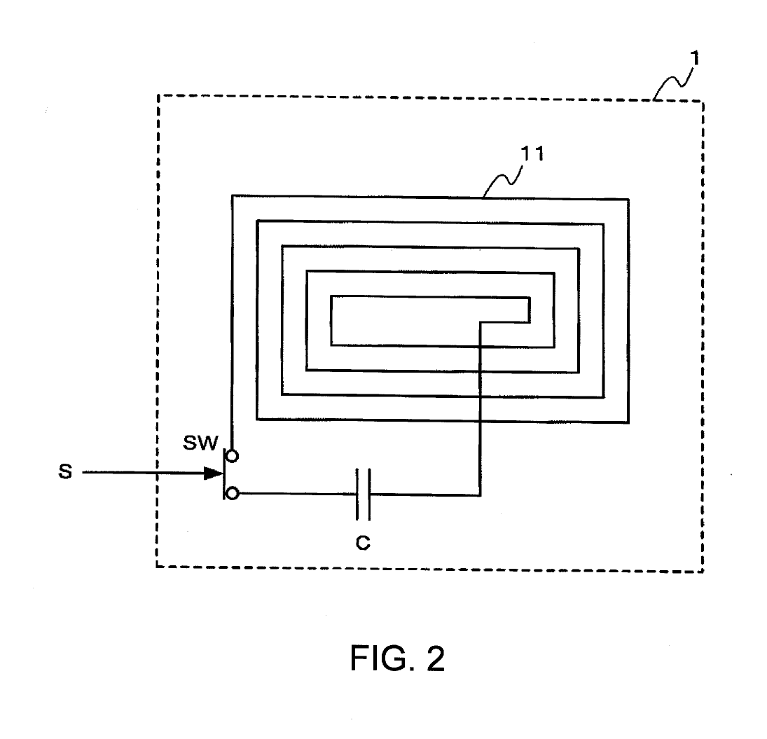

FIG. 2 illustrates a repeater 1 as an example of a configuration of the repeaters 1-1 to 1-9.

The repeater 1 has a repeater coil 11. Further, the repeater 1 has a capacitor C and a switch SW respectively connected to the repeater coil 11 in series. The switch SW enables disconnecting of a current path of the repeater coil 11.

The repeater coil 11 and the capacitor C form a resonant circuit. The resonant circuit resonates between a power transmission device and a power receiving device and performs relaying power transmission with a magnetic resonance.

The repeater device 100 is provided with 9 (nine) measuring units 2-1 to 2-9. The measuring units 2-1 to 2-9 is provided for measuring respective power transfer efficiencies of the repeaters 1-1 to 1-9.

Each of the measuring units 2-1 to 2-9 measures a current flowing through the repeater coil 11 of each of the repeaters 1-1 to 1-9, and calculates a power transfer efficiency of each of the repeaters 1-1 to 1-9 using a ratio of the measured current to an assumed maximum current.

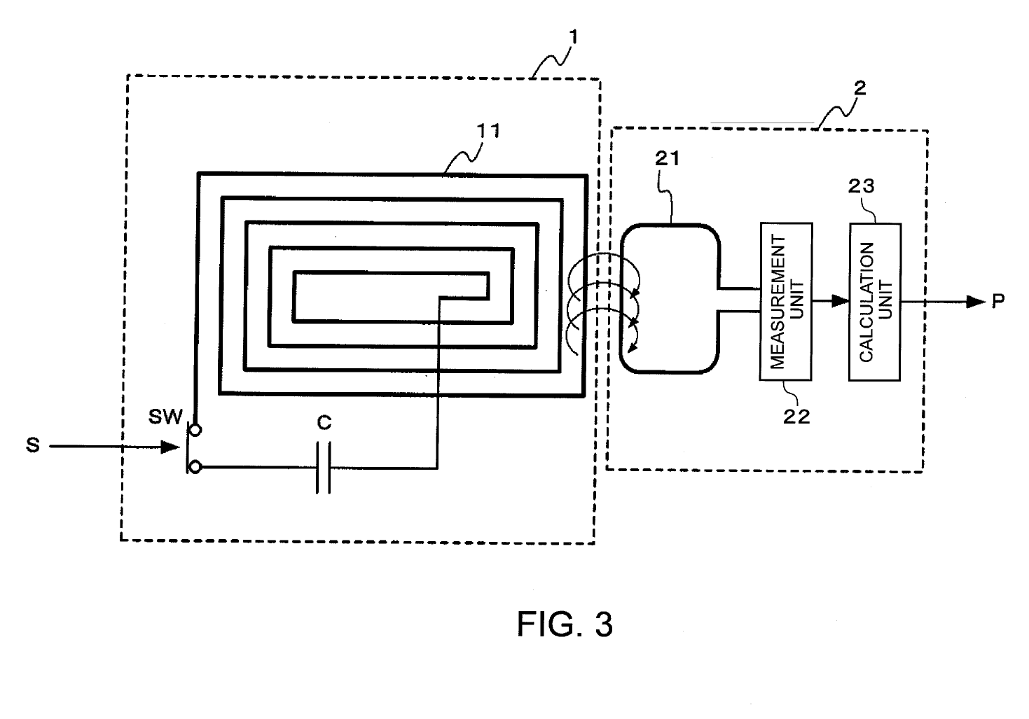

FIG. 3 illustrates the measuring unit 2 as an example of a configuration of the measuring units 2-1 to 2-9. Further, FIG. 3 also illustrates the circuit configuration of the repeater 1 shown in FIG. 2.

The measuring unit 2 is provided with a loop coil 21, a measurement unit 22, and a calculation unit 23. The loop coil 21 is placed closely to the repeater coil 11 of the repeater 1. The measurement unit 22 measures an induced current flowing through the loop coil 21 by electromagnetic induction from the repeater coil 11. The calculation unit 23 calculates a power transfer efficiency of the repeater 1 based on the measuring result obtained from the measurement unit 22.

The calculation unit 23 calculates and outputs a power transfer efficiency P using a ratio of an amount of the measured induced current to an amount of an induced current generated in the loop coil 21 when the assumed maximum current flows through the repeater coil 11.

The current flowing through the repeater coil 11 increases as a resonance between the repeater 1 and the power receiving device is intensified. Accordingly, the power transfer efficiency P represents an efficiency of supply power from the repeater 1 to the power receiving device.

FIG. 1, the repeater device 100 is provided with a control unit 3. The control unit 3 outputs switch control signals S1 to S9 which control switch on and off of the switches SW of the s 1-1 to 1-9 based on the values of power transfer efficiencies P1 to P9 output from the measuring units 2-1 to 2-9. The power transfer efficiencies P1 to P9 correspond to the power transfer efficiency P shown in FIG. 3.

The control unit 3 selects the repeaters 1-1 to 1-9 to be used continuously based on the values of the power transfer efficiencies P1 to P9. One of the following conditions (1) and (2) is adopted as a criterion for the selection.

(1) The power transfer efficiency is the highest.

(2) The power transfer efficiency is higher than a predetermined reference value.

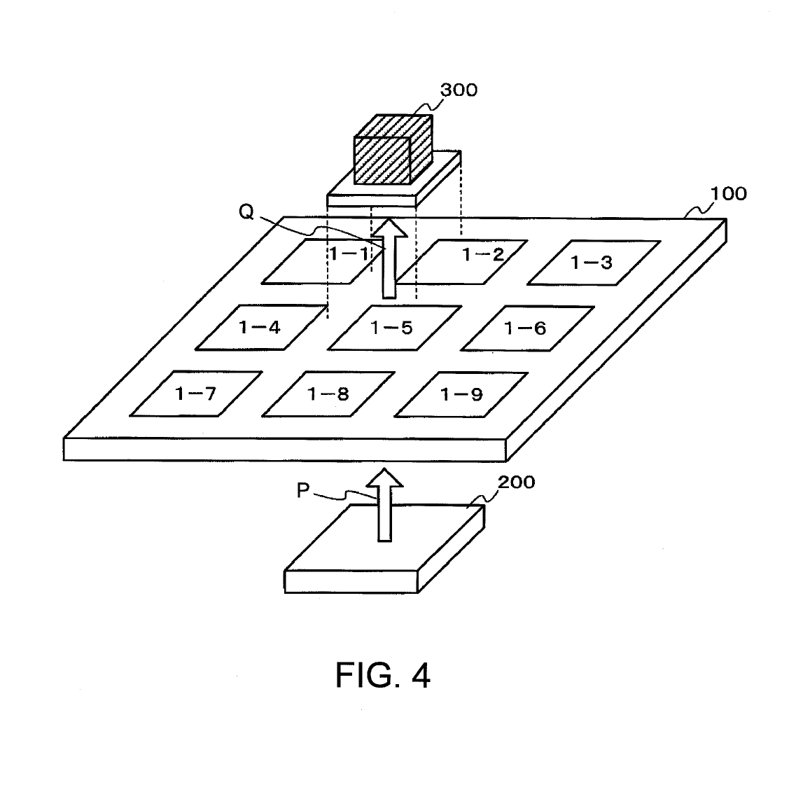

FIG. 4 schematically illustrates an example of a wireless power transfer system using the repeater device 100.

In the system shown in FIG. 4, the plate-shaped repeater device 100 is placed above a power transmission device 200. Further, a power receiving device 300 is placed above a principal surface of the repeater device 100.

Power transmission of power P is performed from the power transmission device 200 to the repeaters 1-1 to 1-9 of the repeater device 100, using magnetic resonance. Power transfer of power Q is performed from the repeaters 1-1 to 1-9 to the power receiving device 300, using magnetic resonance.

An operation of the control unit 3 of the repeater device 100 will be described.

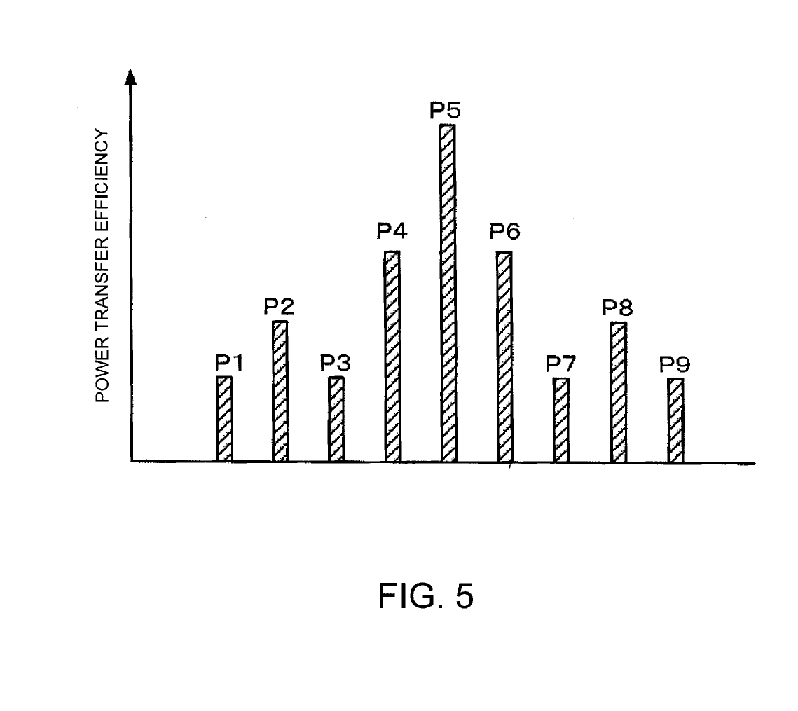

FIG. 5 is a view showing an example of a measurement result obtained by the measuring unit. In FIG. 5, power transfer efficiencies P1 to P9 of the repeaters 1-1 to 1-9 which are measured by the measuring unit 2 are shown. Among the examples, the power transfer efficiency P5 exhibits the highest value.

When the criterion of the selection of the repeaters 1-1 to 1-9 of the control unit 3 is the above-described “(1) A power transfer efficiency is the highest,” the control unit 3 outputs switch control signals S1 to S9 so that only the switch SW of the repeater 1-5 is maintained in a switch-on state continuously, and the switches SW of the other repeaters 1-1 to 1-4 and 1-6 to 1-9 are switched off.

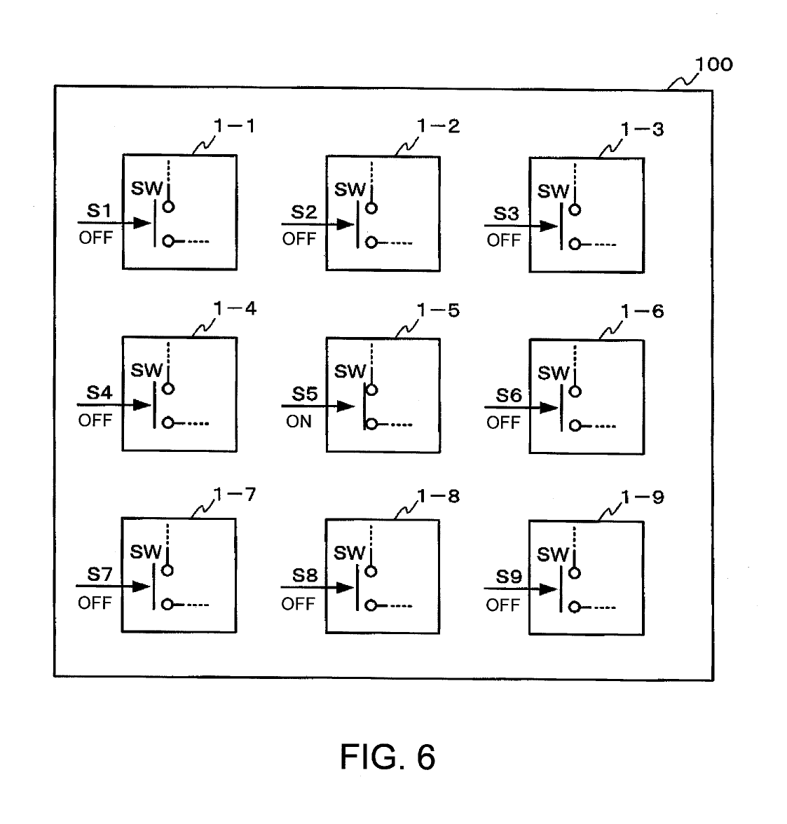

FIG. 6 illustrates a relationship between the switch control signals S1 to S9 provided to the repeaters 1-1 to 1-9 and on and off states of the switches SW of the repeaters 1-1 to 1-9, at this time.

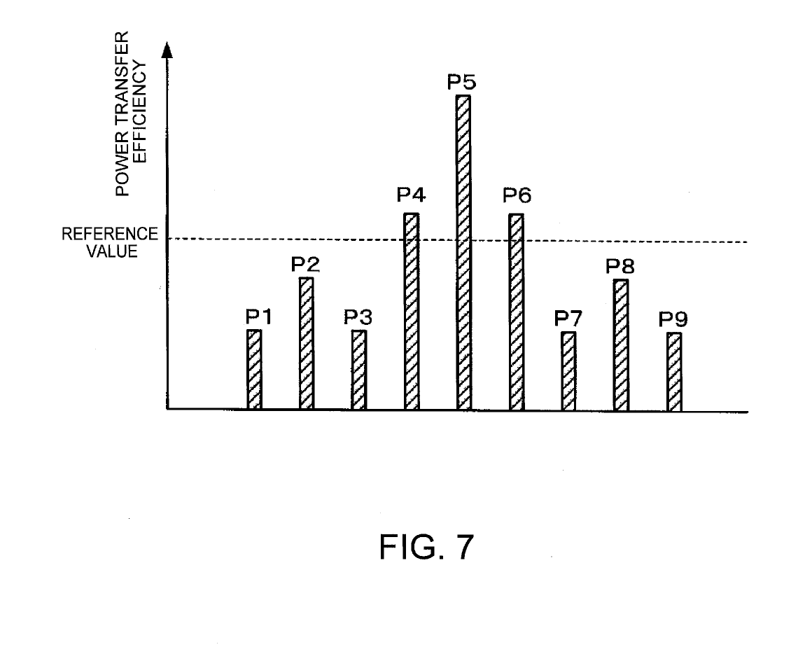

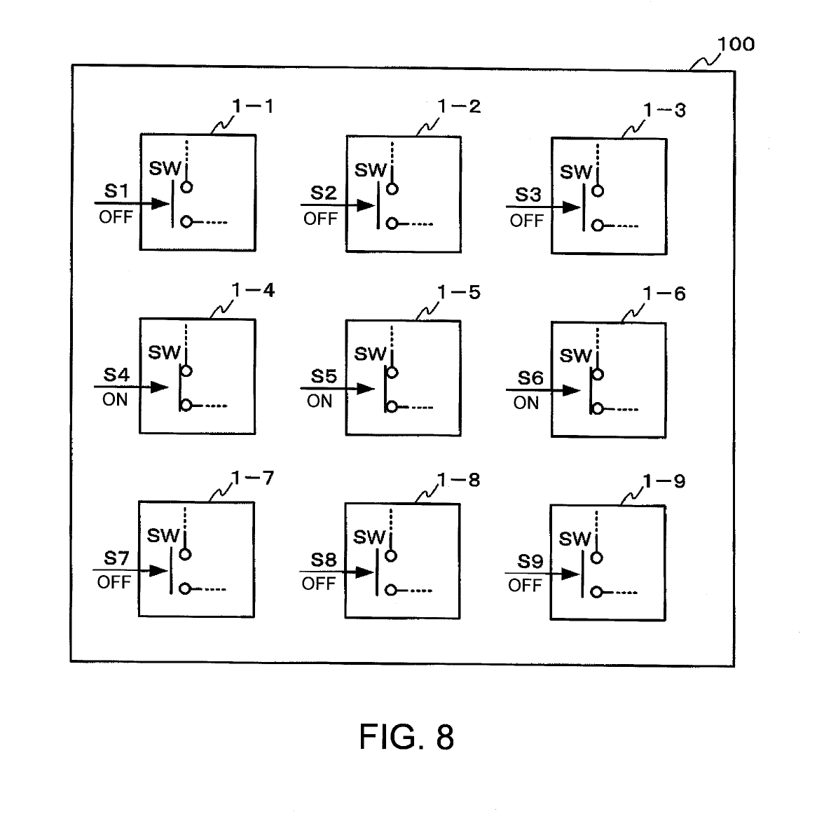

Another example of an operation of the control unit 3 will be described with reference to FIGS. 7 and 8. In this example, as the criterion of the selection of the repeaters 1-1 to 1-9, the above-described “(2) A power transfer efficiency is higher than the predetermined reference value” is adopted.

As shown in FIG. 7, when the power transfer efficiencies P4, P5, P6 among the power transfer efficiencies P1 to P9 are higher than a predetermined reference value, the control unit 3 outputs switch control signals S1 to S9 so that the switches SW of the repeaters 1-4, 1-5 and 1-6 is maintained in a switch-on state continuously and so that the switches SW of the other s 1-1 to 1-3 and 1-7 to 1-9 are switched off.

FIG. 8 illustrates a relationship between the switch control signals S1 to S9 provided to the repeaters 1-1 to 1-9 and open or close states of the switches SW of the repeaters 1-1 to 1-9, at this time.

According to the embodiment, it is possible to measure a power transfer efficiencies of the repeaters, and to select at least one repeater having a high power transfer efficiency among the repeaters in order to use the repeater for wireless power transfer. It is possible to suppress unnecessary wireless power transmission and to transmit an electric power from the power transmission device to the power receiving device wirelessly and effectively.

In the above first embodiment, at least one repeater having a high power transfer efficiency is selected, and switches SW of the other repeaters are switched off. If the switches SW of the other repeaters are switched off continuously without being switched on, an inconvenience can occur in power transfer when another power receiving device is added and placed above the repeater device 100. A repeater device for wireless power transfer according to a second embodiment enables power transfer which follows an placement of such an additional power receiving device or a shift of a position of the power receiving device above the repeater device. The repeater device of the second embodiment includes configurations shown in FIG. 1 to FIG. 3. An operation of a control unit which is provided in the repeater device of the second embodiment will be described.

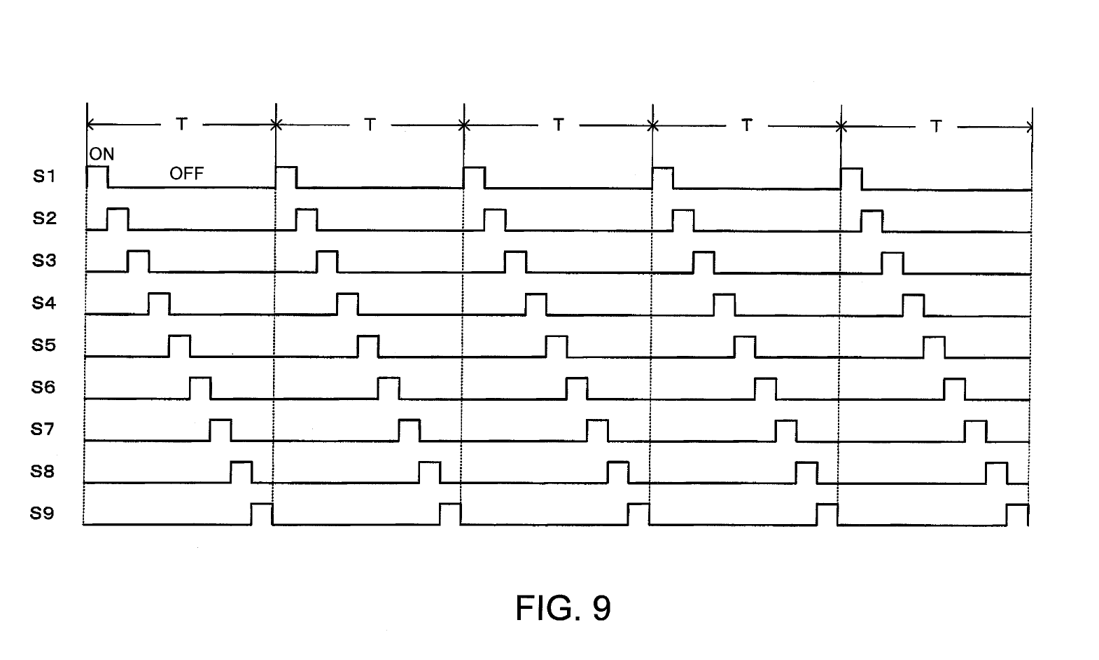

FIG. 9 illustrates output waveforms of switch control signals S1 to S9 which are provided when any power receiving device is not placed above the repeater device.

The control unit 3 changes the levels of the respective switch control signals S1 to S9 between switch-on (High) and switch-off (Low) levels, with a period T. The timings of the switch-on (High) levels of the switch control signals S1 to S9 are shifted sequentially in this order by a term of the switch-on (High) levels. The control unit 3 investigates presence of the power receiving device. In other words, the control unit 3 performs polling presence of the power receiving device based on changes of values of power transfer efficiencies P1 to P9 output from the measuring units 2-1 to 2-9, during each period T.

After performing the polling during each period T, the control unit 3 calculates the amounts of the changes between the power efficiencies P1 to P9 and those calculated during each previous period T. When a plurality of the repeaters indicating a calculated amount of change which is higher than a predetermined value are detected, a switch SW of one of the plurality of the repeaters 1-1 to 1-9 which shows the highest power transfer efficiency among the repeaters 1-1 to 1-9 is kept in a switch-on state continuously from the next period.

After the switch SW of the one of the plurality of the repeaters 1-1 to 1-9 is kept in a switch-on state continuously, the control unit 3 continues the polling operation as the control unit 3 has done. Every time a change in power transfer efficiency is detected, a switch SW of each one of the repeaters 1-1 to 1-9 which indicates that an amount of change of power transfer efficiency is higher than the predetermined value is kept in a switch-on state continuously from the next period as described above.

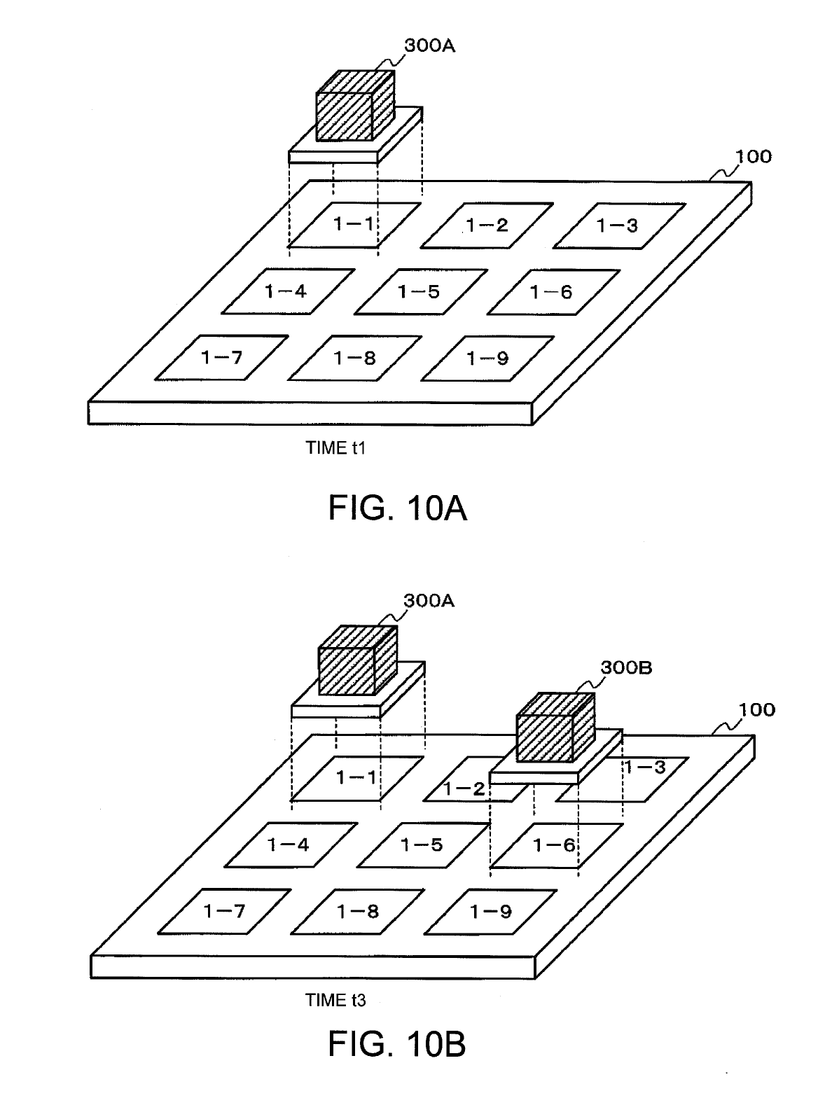

It is assumed, for example, that, a power receiving device 300A is placed above the repeater device 100 for wireless power transfer as shown in FIG. 10A at time t1, and that a power receiving device 300B is additionally placed above the repeater device 100 as shown in FIG. 10B at time t3, subsequently.

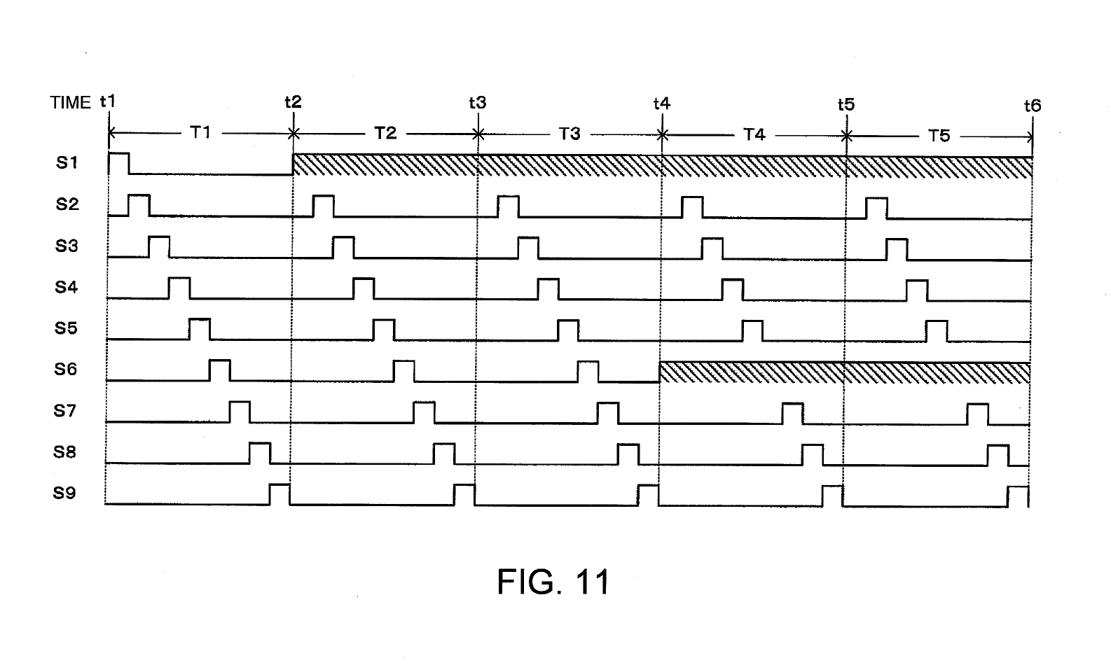

Waveform changes of the switch control signals S1 to S9 with time in this case are illustrated in FIG. 11.

It is assumed that, when the power receiving device 300A is placed above the repeater device 100 at the time t1, the amount of change of the power transfer efficiency P1 is higher than the predetermined value and the power transfer efficiency P1 is the highest compared to the other power transfer efficiencies P2 to P9 having a change respectively, as a polling result obtained during a period T1. In this case, the switch control signal S1 is kept in a switch-on state continuously after a period T2.

It is assumed that, when the power receiving device 300B is additionally placed above the repeater device 100 at the time t3 subsequently, the amount of change of the power transfer efficiency P6 is higher than the predetermined value and the power transfer efficiency P6 is the highest compared to the remaining power transfer efficiencies P2 to P5 and P7 to P9 having a change respectively, as a polling result obtained during a period T3. In this case, the switch control signal S6 is kept in a switch-on state continuously after a period T4.

When a power receiving device 300A or 300B is removed, the value of the power transfer efficiency of the repeater in the removed device 300A or 300B which has performed power transfer to the power receiving device is reduced. Accordingly, when a reduction in power transfer efficiency is detected as a result of polling, the switch control signal to be provided to the where the reduction is detected returns from the above-described continuous switch-on (High) level to the periodical level change as before.

According to the embodiment, all of the repeaters are switched on and off periodically and the changes of power transfer efficiency of the repeaters are monitored so that polling of the arrangement of a power receiving device can be constantly performed. As a result, even when the number of power receiving devices or the placement position of a power receiving device is changed, an optimal which responds to the change can be selected among the repeaters.

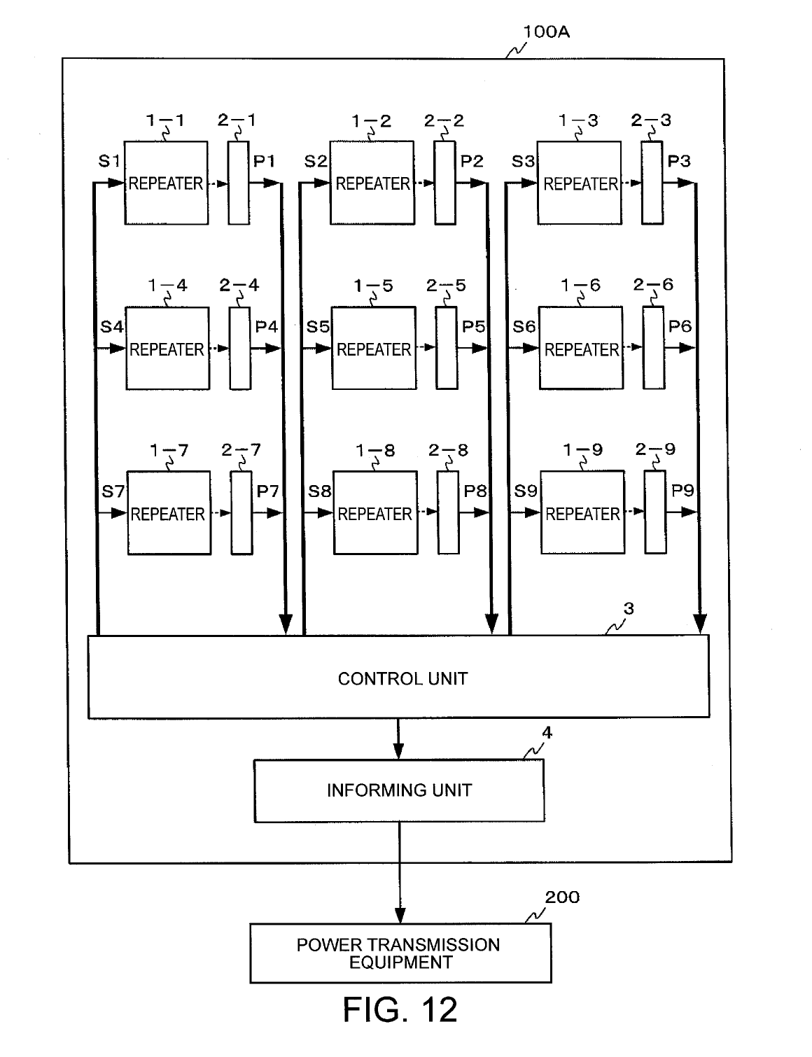

FIG. 12 is a block diagram showing an example of a repeater device for wireless power transfer according to a third embodiment.

A repeater device 100A of the embodiment is provided with an informing unit 4 which is added to the repeater device 100 of the first embodiment.

The informing unit 4 informs a power transmission device 200 of information as to power transfer efficiencies P1 to P9 and information of switch-on (High) and switch-off (Low) levels of switch control signals S1 to S9.

The power transmission device 200 determines whether supply power of a repeater in a switch-on state is excessive or insufficient, based on the information transmitted from the informing unit 4. Transmission power is increased when the power is insufficient, and the transmission power is decreased when the supply power is excessive.

According to the embodiment, since it is possible to informs the power transmission device 200 of information as to situations of relaying power in the repeaters 1-1 to 1-9, the power transmission device 200 can adjust the amount of the transmission power based on the information.

According to the repeater device of the embodiments described above, a repeater device having repeaters placed in a plane substantially is provided, and an electric power can be ed efficiently from a power transmission device below the repeater device to a power receiving device placed above the repeater device

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A repeater device for wireless power transfer, comprising:
repeaters for supply power wirelessly which are placed in a plane substantially, each of the repeaters having a repeater coil and a switch which enables disconnection of a current path of the repeater coil;
measuring units for measuring power efficiencies of the repeaters respectively; and
a control unit for controlling switching-on and switching-off of the switches of the repeaters based on a measuring result of the power transfer efficiencies obtained from the measuring units.

2. The device according to claim 1, wherein the control unit keeps in a switch-on state continuously the switch of one of the repeaters which indicates the highest power transfer efficiency among the power transfer efficiencies measured by the measuring units, and the control unit switches off the switches of the remaining repeaters.

3. The device according to claim 1, wherein the control unit keeps in a switch-on state continuously the switch of at least one of the repeaters which indicates a measured power transfer efficiency higher than a predetermined value, and the control unit switches off the switches of the remaining repeaters.

4. The device according to claim 1, wherein the control unit switches on the switches of the repeaters periodically so as to monitor changes of power transfer efficiencies of the repeaters, and the control unit keeps in a switch-on state continuously the switch of one of the repeaters indicating the highest power transfer efficiency among the s in which the changes are detected when it is detected that the amounts of the changes are higher than a predetermined value.

5. The device according to claim 1, wherein the control unit switches on the switches of the repeaters periodically so as to monitor changes in power transfer efficiencies of the repeaters, the control unit keeps in a switch-on state continuously the switch of at least one of the repeaters indicating a measured power transfer efficiency higher than a predetermined value, and the control unit switches off the switches of the remaining repeaters.

6. The device according to claim 1, wherein the control unit keeps the switches of the repeaters in a switch-on state continuously, monitors changes of power transfer efficiencies, and makes the switch of any one of the repeaters in which the change is detected in a periodical switch-on state when it is detected that the amount of the change is lower than a predetermined value

7. The device according to claim 1, further comprising an informing unit that informs a power transmission device of information as to the power transfer efficiencies and information as to switch-on and switch-off of the switches, wherein transmission power from the power transmission device is increased or decreased based on the information from the informing unit.

8. The device according to claim 2, further comprising an informing unit that informs a power transmission device of information as to the power transfer efficiencies and information as to switch-on and switch-off of the switches, wherein transmission power from the power transmission device is increased or decreased based on the information from the informing unit.

9. The device according to claim 3, further comprising an informing unit that informs a power transmission device of information as to the power transfer efficiencies and information as to switch-on and switch-off of the switches, wherein transmission power from the power transmission device is increased or decreased based on the information from the informing unit.

10. The device according to claim 4, further comprising an informing unit that informs a power transmission device of information as to the power transfer efficiencies and information as to switch-on and switch-off of the switches, wherein transmission power from the power transmission device is increased or decreased based on the information from the informing unit.

11. The device according to claim 5, further comprising an informing unit that informs a power transmission device of information as to the power transfer efficiencies and information as to switch-on and switch-off of the switches, wherein transmission power from the power transmission device is increased or decreased based on the information from the informing unit.

12. The device according to claim 6, further comprising an informing unit that informs a power transmission device of information as to the power transfer efficiencies and information as to switch-on and switch-off of the switches, wherein transmission power from the power transmission device is increased or decreased based on the information from the informing unit.

13. The device according to claim 1, wherein each of the measuring units has a loop coil placed closely to the repeater coil, and calculates a power transfer efficiencies based on an amount of an induced current flowing through the loop coil.

14. The device according to claim 2, wherein each of the measuring units has a loop coil placed closely to the repeater coil, and calculates a power transfer efficiency based on an amount of an induced current flowing through the loop coil.

15. The device according to claim 3, wherein each of the measuring units has a loop coil placed closely to the repeater coil, and calculates a power transfer efficiency based on an amount of an induced current flowing through the loop coil.

16. The device according to claim 4, wherein each of the measuring units has a loop coil placed closely to the repeater coil, and calculates a power transfer efficiency based on an amount of an induced current flowing through the loop coil.

17. The device according to claim 5 wherein each of the measuring units has a loop coil placed closely to the repeater coil, and calculates a power transfer efficiency based on an amount of an induced current flowing through the loop coil.

18. The device according to claim 6 wherein each of the measuring units has a loop coil placed closely to the repeater coil, and calculates a power transfer efficiency based on an amount of an induced current flowing through the loop coil.
